(19) United States
(12) Patent Application Publication
(10) Pub. No.: US 2013/0183207 A1
(43) Pub. Date: Jul. 18, 2013

(54) Treatment Apparatus for Evaporated Fuel

(71) Applicant: Aisan Kogyo Kabushiki Kaisha, Obu-shi (JP)

(72) Inventors: Junya Kimoto, Obu (JP); Takanori Akiyama, Nagoya (JP)

(73) Assignee: AISAN KOGYO KABUSHIKI KAISHA, Obu-shi (JP)

(21) Appl. No.: 13/739,662

(22) Filed: Jan. 11, 2013

(30) Foreign Application Priority Data
Jan. 18, 2012 (JP) 2012-008291

(51) Int. Cl. B01D 53/02

(52) U.S. Cl. CPC B01D 53/02
USPC 422/255

(57) ABSTRACT

A treatment apparatus for evaporated fuel including tank port, a purge port, an atmosphere port, a channel communicating the tank port or the purge port and the atmosphere port, and plural adsorption chambers having adsorbent therein, which adsorbing and desorbing a fuel component of evaporated fuel, wherein the adsorption chamber closest to the atmosphere port has a major diameter portion filled with the adsorbent over all a cross section of the charmed a projecting portion projecting from the major diameter portion toward the atmosphere port and filled with the adsorbent, and a space portion between the projecting portion and an inner wall of the channel and not filled with the adsorbent, and end surfaces of the major diameter portion and the projecting portion on the atmosphere port side are breathable so as to control temperature drop in activated carbon and to thereby enhance bleed emission performance.

### BACKGROUND OF THE INVENTION

(1) Field of the Invention

The preset invention relates to a treatment apparatus for evaporated fuel.

(2) Description of Related Art

In order to prevent evaporated, fuel from being released to the atmosphere from an automobile fuel task or the like, a treatment apparatus for evaporated fuel (hereinafter also referred to as a canister) is conventionally used which temporarily adsorbs a fuel component in the evaporated fuel.

In recent years, it is desired in the canister to reduce an amount of evaporated fuel released to the atmosphere. Accordingly, it is known that an adsorption chamber which is positioned closest to an atmosphere port and is fitted with activated carbon is made to have a smaller cross section toward the atmosphere port, so that the adsorption chamber close to the atmosphere port is to have a larger ratio of length to cross sectional diameter (L/D) in order to decrease the amount of bleed emissions to the atmosphere (see IP-A-2009-250059).

In recent years, since purging time is decreased for improving fuel efficiency in a vehicle such as the automobile, a purge flow rate per time tends to be increased. However, while desorption from activated carbon is promoted as the purge flow rate per time is increased, there is a problem that the activated carbon rapidly drops in temperature, efficiency of desorption from the activated carbon is reduced, a residual amount of the evaporated fuel in the activated carbon is increased, and a bleed emission performance is deteriorated.

Purging air, which is cooled on the atmosphere port side, flows to the activated carbon on the purge port side which adsorbs a large amount of the fuel component. As a result, the activated carbon is further cooled, which increases a density difference in the fuel component between on the purge port side and on the atmosphere port side. When the density difference is large, the fuel component tends to diffuse from the purge port side toward the atmosphere port side. As a result, a residual amount of the fuel component around the atmosphere port is increased, whereby the bleed emission performance is deteriorated.

### BRIEF SUMMARY OF THE INVENTION

An object of the present invention is to provide a treatment apparatus for evaporated fuel with enhanced bleed emission performance achieved by suppressing temperature drop in activated carbon.

In order to accomplish the above-stated object, a treatment apparatus for evaporated fuel according to the present invention includes: a tank port, a purge port; an atmosphere port; a channel that communicates between the tank port or the purge port and the atmosphere port, and, a plurality of adsorption chambers having adsorbent placed therein, the adsorbent adsorbing and desorbing a fuel component of evaporated fuel, wherein

the adsorption chamber positioned closest to the atmosphere port has: a major diameter portion filled with the adsorbent over all a cross section of the channel; a projecting portion that projects from the major diameter portion toward the atmosphere port and is filled with the adsorbent; and a space portion that is formed between the projecting portion and an inner wall of the channel and is not filled with the adsorbent, and

end surfaces of the major diameter portion and the projecting portion on the atmosphere port side are breathable.

In the present invention, a partition well may be provided between the projecting portion and the space portion so as to block air flow between an outer peripheral surface of the projecting portion and an inner peripheral surface of the space portion.

According to the present invention, since the adsorption chamber positioned closest to the atmosphere port has: the major diameter portion filled with adsorbent over all the cross section of the channel; the projecting portion that projects from the major diameter portion toward the atmosphere port and is fitted with the adsorbent; and the space portion that is formed between the projecting portion and the inner wall of the channel and is not filled with the adsorbent, air which flows in from the atmosphere port at the time of purging goes into the projecting portion and into the space portion around an outer periphery thereof. The air which flows into the projecting portion is cooled by desorption of a fuel component from the adsorbent, whereas the air which flowed into the space portion is not cooled as it does not come into contact with the adsorbent. Since the major diameter portion receives inflow of the cooled gas and uncooled gas, it becomes possible to alleviate drop of the gas temperature in the major diameter portion and to thereby suppress deterioration in efficiency of desorption from the adsorbent, as compared with the conventional technology.

Accordingly, as compared with the conventional technology, it becomes possible to decrease a density difference between the fuel component on the purge port side and the fuel component on the atmosphere port side in the adsorption chamber as well as to reduce a residual amount of the evaporated fuel in the adsorption chamber positioned closest to the atmosphere port so that bleed emission performance can be enhanced.

### BRIEF DESCRIPTION OF SEVERAL VIEWS OF DRAWING

FIG. 1 is a schematic cress sectional view showing a treatment apparatus for evaporated fuel according to Embodiment 1 of the present invention;

FIG. 2 is a partially enlarged schematic cross sectional view of FIG. 1;

FIG. 3A is a top view showing a space portion formation member for use in Embodiment 1 of the present invention, while FIG. 3B is a longitudinal sectional view of the space portion formation member;

FIG. 4 is a partially enlarged schematic cross sectional view showing a treatment apparatus for evaporated fuel according to Embodiment 2 of the present invention;

FIG. 5 is a partially enlarged schematic cross sectional view showing a treatment apparatus for evaporated fuel according to Embodiment 3 of the present invention;

FIG. 6 is a partially enlarged schematic cross sectional view showing a treatment apparatus for evaporated fuel according to Embodiment 4 of the present invention; and

FIG. 7 is a schematic cross sectional view showing a treatment apparatus for evaporated fuel according to Embodiment 5 of the present invention.

### DETAILED DESCRIPTION OF THE INVENTION

The embodiments according to the present invention will be explained with reference to the drawings.

### Embodiment 1

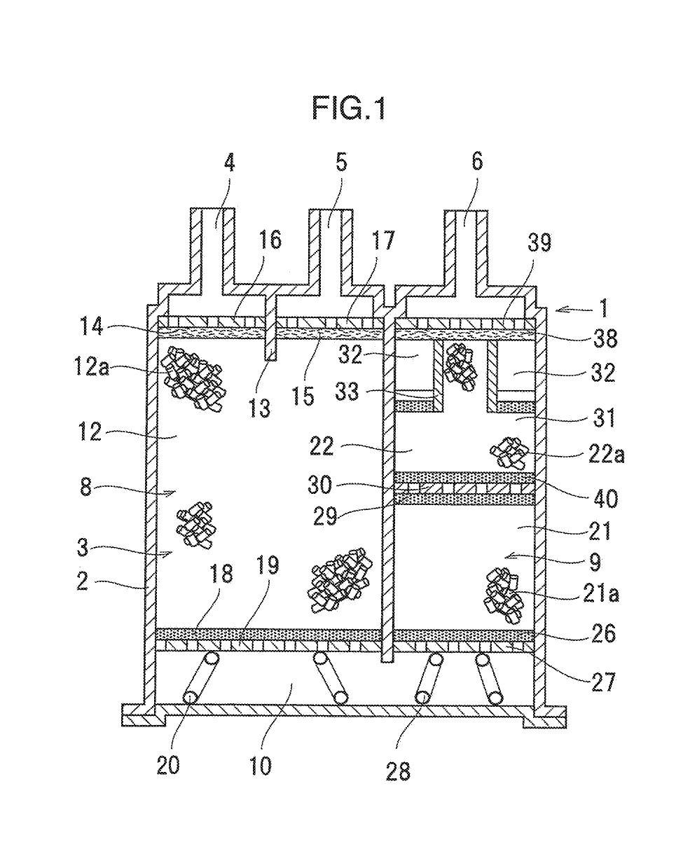

Embodiment 1 according to the present invention is shown in FIGS. 1 to 3B,

FIG. 1 is a schematic cross sectional view showing a treatment apparatus for evaporated fuel 1 according to Embodiment 1. The treatment apparatus for evaporated fuel 1 has a case 2, in which a channel 3 is formed so that fluid such as gas can pass therethrough. As shown in FIG. 1, a tank port 4 and a purge port 5 are formed in one end portion of the channel 3 in the case 2, while an atmosphere port 6 is formed in the other end portion thereof.

In the case 2, a main chamber 8 that is communicated with the tank port 4 and with the purge port 5, and an sub chamber 9 that is commnunicated with the atmosphere port 6 are formed. As shown in FIG. 1, the main chamber 8 and the sub chamber 9 are comparted, and they are communicated with each other through a space 10 which is formed on the opposite side of the atmosphere port 6 in the case 2. When gas flows into the atmosphere port 6 from the tank port 4, the gas turns back at the space 10 so as to flow generally in a U-shaped course.

The tank port 4 is communicated with an upper air chamber of a fuel tank via an unshown valve, and the purge port 5 is connected to a suction passage of an engine via an unshown purge control valve (VSV) and an unshown purging passage. An opening of the purge control valve is controlled by an electronic control unit (ECU), and purge control is performed during engine operation. The atmosphere port 6 is communicated with the outside air.

Between the tank port 4 and the purge port 5 in the case 2, a baffle plate 13 is provided which extends from an internal surface of the case 2 op to a part of a later-described first adsorption chamber 12. With the presence of the baffle plate 13, the fluid flowing between the task port 4 and the purge port 5 travels through the later-described first adsorption chamber 12.

In the main chamber 8, a first adsorption chamber 12 is provided which is filled with adsorbent 12a, such as activated carbon capable of adsorbing and desorbing an evaporated fuel component, at prescribed density. As the adsorbent 12a, formed coal with a prescribed mean particle diameter is used in the present embodiment. It is to be noted that crushed granulated coal may also be used as the adsorbent 12a.

The first adsorption chamber 12 is covered on the tank port 4 side with a filter 14 made of nonwoven fabrics or the like, and on the purge port 5 side with a filter 15 made of nonwoven fabrics or the like. A plate 16 having a large number of communicating holes is provided on the tank port 4 side of the filter 14, and a plate 17 having a large number of communicating holes is provided on the purge port 5 side of the filter 15. A filter 18 made of urethane or the like is provided so as to cover an entire surface of the first adsorption chamber 12 on the space 10 side, and a plate 19 having a large number of communicating holes is provided on the space 10 side of the filter 18. The plate 19 is biased by biasing means 20, such as a spring, toward the tank port 4.

In the sub chamber 9, there are provided in series in order from the tank port 4 side, a second adsorption chamber 21 that is filled with absorbent 21a such, as activated carbon capable of adsorbing and desorbing an evaporated fuel component, at a prescribed density, and a third adsorption chamber 22 having adsorbent 22a such as activated carbon capable of adsorbing and desorbing an evaporated fuel component. In the present embodiment, formed coal with a prescribed mean particle diameter is used as the adsorbents 21a and 22a. It is to be noted that crushed granulated coal may also be used as the adsorbents 21a and 22a.

A filter 26 that is made of urethane and the like is provided so as to cover an entire portion of the second adsorption chamber 21 on the space 10 side. A plate 27 having a large number of communicating holes generally evenly provided on the entire surface thereof is provided on the filter 26 on the space 10 side. The plate 27 is biased by a biasing member 28, such as a spring, toward the atmosphere port 6.

A filter 29 that is made of urethane ad the like is provided in the second adsorption chamber 21 on the third adsorption chamber 22 side. A plate 30 having a large number of communicating holes generally evenly provided on the entire surface thereof is provided in the filter 29 on the third adsorption chamber 22 side.

Now, the third adsorption chamber 22 will be described in detail.

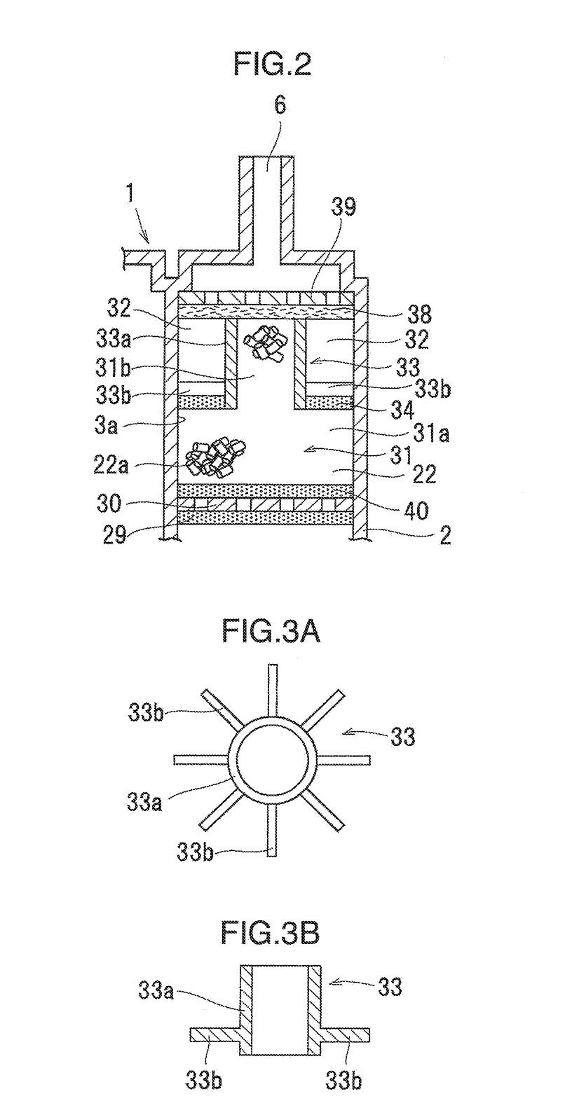

The third adsorption chamber 22 has an adsorbent filling portion 31 filled with adsorbent 22a and a space portion 32 that is not filled with adsorbent as shown in FIGS. 1 and 2.

The adsorbent filling portion 31 includes a major diameter portion 31a that is filled with the adsorbent 22a over all the cross section of the channel 3 and a projecting portion 31b that projects from the major diameter portion 31a toward the atmosphere port 6 as shown in FIG. 2. The major diameter portion 31a and the projecting portion 31b are integrally formed with each other.

A space portion formation member 33 is provided in the major diameter portion 31a on the atmosphere port 6 side. The space portion formation member 33 includes a cylindrical partition wall 33a and a plurality of suppressing portions 33b that project toward a radial outside from an end portion of the partition wall 33a on the major diameter portion 31a side as shown in FIGS. 3 A and 3B. A central axis of the partition wall 33a is made generally concentric with an axial center of the atmosphere post 6 in the vicinity of the treatment apparatus for evaporated fuel 1.

The adsorbent 22a is filled in the cylindrical partition wall 33a to constitute the projecting portion 31b. and the space portion 32 is formed between an outer peripheral surface of the partition wall 33a and an inner wall 3a of the channel 3. Between the suppressing portions 33b and the major diameter portion 31a, a fitter 34 is provided which is made of annular urethane or the like. Airflow resistance of the filter 34 is properly set depending on a purge amount, performance required of the treatment apparatus for evaporated fuel 1 and so on. By changing the airflow resistance of the filter 34, a flow rate of inflow air from the atmosphere port 6 flowing into the projecting portion 31b, and a flow rate of use inflow air flowing into the space portion 32 can be adjusted.

A filter 38 that is made of nonwoven fabrics or the like is provided so as to cover an end portion of the third adsorption chamber 22 on the atmosphere port 6 side, i.e., an entire end portion of the projecting portion 31b and the space portion 32 on the atmosphere port 6 side. A plate 39 having a large number of communicating holes provided generally evenly on the entire surface thereof is provided on the filter 38 on the atmosphere port 6 side. A filter 40 that is made of urethane or the like is provided so as to cover an entire portion of the major diameter portion 31a on the space 10 side.

With the above-stated configuration, the gas containing the evaporated fuel, which flowed from the tank port 4 into the treatment apparatus for evaporated fuel 1, flows through the first adsorption chamber 12, the space chamber 10, the second adsorption chamber 21, and the third adsorption chamber 22, and then, is released to the atmosphere from the atmosphere port 6. During this process, the fuel component is adsorbed by the adsorbents 12a, 21a, and 22a.

In the purge control during engine operation, the purge control valve is opened by the electronic control unit (ECU), so that air which is stroked from the atmosphere port 6 into the third adsorption chamber 22 of the treatment apparatus for evaporated fuel 1 by negative pressure inside a suction passage flows into the projecting portion 31b and the space portion 32. The air that flowed into the projecting portion 31b desorbs the fuel component, which has been adsorbed by the adsorbent 22a in the projecting portion 31b, while at the same time the air is cooled and the cooled air flows into the major diameter portion 31a. On the other hand, the air that flows into the space portion 32 maintains its temperature as it is, and flows into the major diameter portion 31a. It is to be noted that the partition wall 33a functions to prevent the gas inside the space portion 32 from directly flowing into the projecting portion 31b.

The major diameter portion 31a receives inflow of the gas which is cooled by passing through the projecting portion 31b and the gas which is not cooled as it passed through the space portion 32, so that temperature drop of the gas inside the major diameter portion 31a can be alleviated and deterioration in efficiency of desorption from the adsorbent 22a can be suppressed as compared with the conventional technology. As a result, it becomes possible to reduce a residual amount of the evaporated fuel in the third adsorption chamber 22 and to enhance bleed emission performance as compared with the conventional technology.

In Embodiment 1, the projecting portion 31b is formed into a cylindrical shape. However, any shape can be employed as long as the diameter of the projecting portion 31b can be made smaller than that of the major diameter portion 31a, and the space portion 32 can be formed on an outer peripheral portion of the projecting portion 31b. It is preferable to form, tire projecting portion 31b in generally the same shape over all an axial direction thereof, such as s cylindrical shape whose cross section is a circular or oval shape, and a prismatic shape whose cross section is a polygon shape such as a square shape and a hexagonal shape.

Moreover, it is preferable to provide the partition wall 33a between the space portion 32 and the major diameter portion 31a so as to prevent the gas in the space portion 32 from directly flowing into the projecting portion 31b. However, it is also possible to provide a communicating hole in the partition wall 33a or to omit provision of the partition wall 33a so that air can flow between the space portion 32 and the major diameter portion 31a.

### Embodiment 2

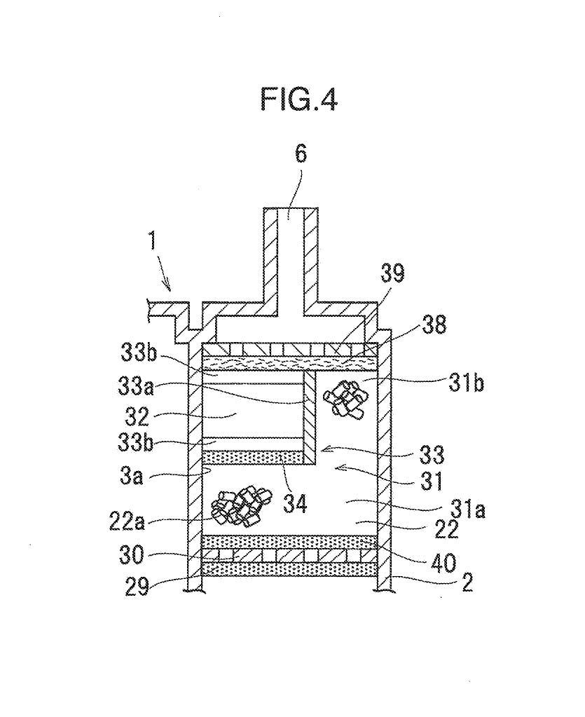

In Embodiment 1, the central axis of the partition wall 33a, i.e. the axial center of the projecting portion 31b in the channel 3 direction, is formed generally concentric with the axial center of the atmosphere port 6 in the vicinity of the treatment apparatus for evaporated fuel 1. However, as shown in FIG. 4, for example, the axial center of the projecting portion 31b in the channel 3 direction may be formed non concentric with the axial corner of the atmosphere port 6 in the vicinity of the treatment apparatus for evaporated fuel 1.

Since other configuration aspects are similar to those in Embodiment 1, the description thereof will be omitted.

In Embodiment 2, the same effects as those in Embodiment 1 can also be implemented.

### Embodiment 3

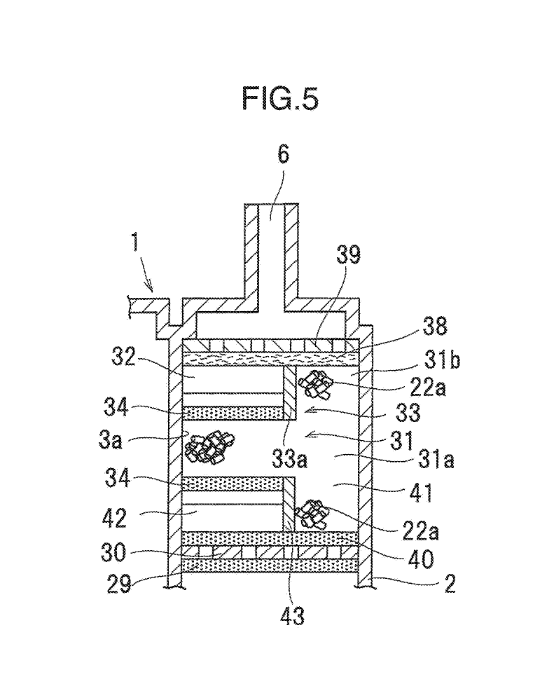

In Embodiment 3, for example, as shown in FIG. 5, a second projecting portion 41 is provided which projects from the major diameter portion 31a of Embodiment 1 or 2 toward the second adsorption chamber 21. The second projecting portion 41, the major diameter portion 31a, and the projecting portion 31b are integrally formed with one another. A second space portion 42 is provided between an outer peripheral portion of the second projecting portion 41 and the inner wall 3a of the channel 3, and a partition wall 43 is formed between the second projecting portion 41 and the second space portion 42. The partition wall 43 prevents fluid from directly flowing between the second space portion 42 and the second projecting portion 41.

Although it is preferable to provide the partition wall 43 to prevent the fluid from directly flowing between the second space portion 42 and the second projecting portion 41, it is also possible to allow air bow between the second space portion 42 and the second projecting portion 41 by providing a communicating hole on the partition wall 43 or by omitting provision of the partition wall 43.

In FIG. 5, although an axial center of the projecting portion 31b in the channel 3 direction is formed generally concentric with an axial center of the second projecting portion 41 in the channel 3 direction, they may be formed non concentric with each other. The axial center of the second projecting portion 41 in the channel 3 direction and the axial center of the atmosphere port 6 in the vicinity of the treatment apparatus for evaporated fuel 1 may be formed concentric or non concentric with each other.

Since other configuration aspects are similar to those in Embodiments 1 and 2, the description thereof will be omitted.

In Embodiment 3, the same effects as those in Embodiments 1 and 2 can also be implemented.

### Embodiment 4

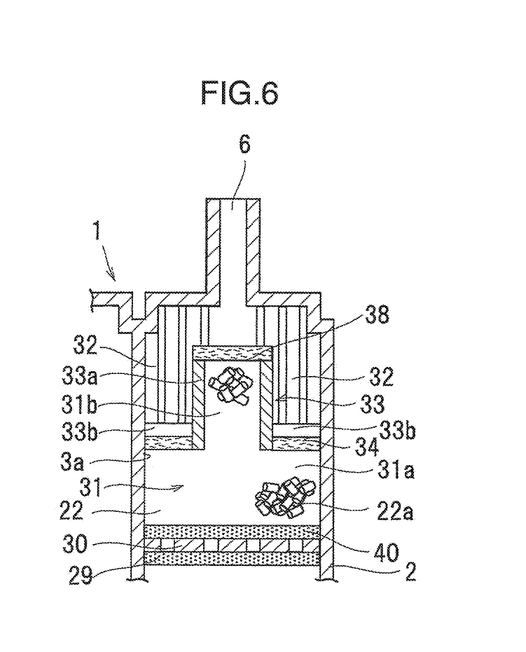

In Embodiments 1 to 3, the filter 33 is provided so that the entire end portion of the space cordons 32 and 42 on the atmosphere port 6 side is covered. However, for example, as shown in FIG. 6, the filter 38 may be formed so that only the entire end portion of the projecting portion 31b on the atmosphere port 6 side is covered.

Resistance of the gas, which passes the filter 34 that covers a portion of the major diameter portion 31a on the atmosphere port 6 side, is properly set depending on parameters such as a purge amount and performance required of the treatment apparatus for evaporated fuel 1.

Since other configuration aspects are similar to those in Embodiments 1 to 3, the description thereof will be omitted.

In Embodiment 4, the same effects as those in Embodiments 1 to 3 can also be implemented.

### Embodiment 5

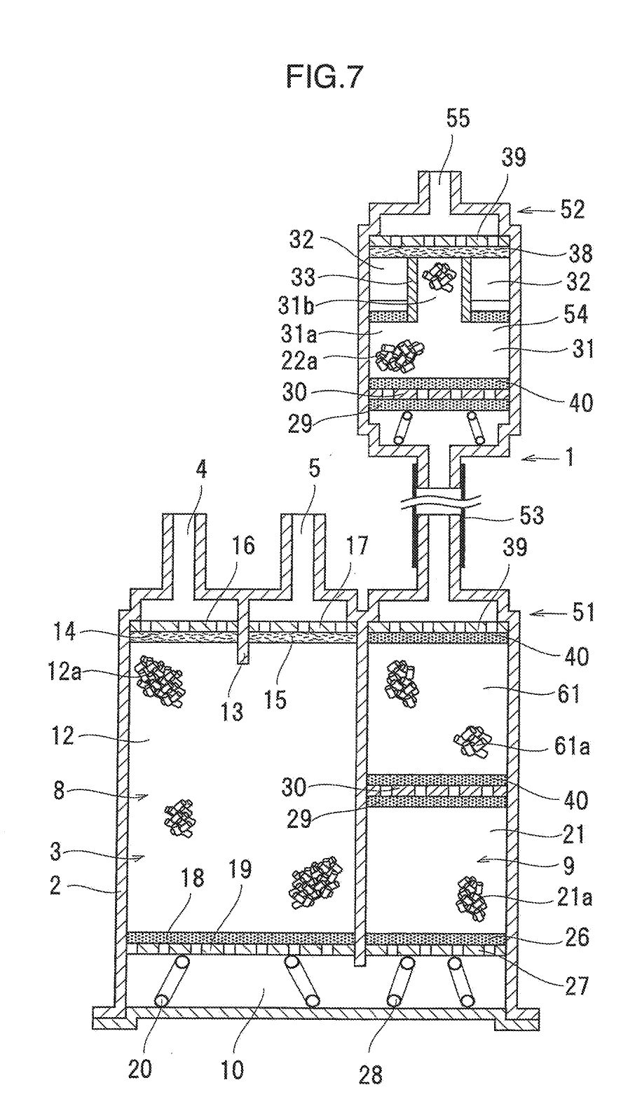

In Embodiments 1 to 4, the entire treatment apparatus for evaporated fuel 1 is formed in one case 2. However, as shown in FIG. 7, the treatment apparatus for evaporated fuel 1 may include a main-body canister 51, a trap canister 52, and a hose 53 that communicates the main-body canister 51 and the trap canister 52. The trap canister 32 may include an adsorption chamber 54 provided therein, the adsorption chamber 54 having a. major diameter portion 31a and a projecting portion 31b that are filled with adsorbent and a space portion 32 that is not filled with adsorbent and formed on an outer peripheral portion of the projecting portion 31b. The adsorption chamber 54 is formed to have generally the same configuration as the third adsorption chamber 22 in Embodiment 1 to 4. If the trap canister 52 is provided, a port formed on the opposite side of the main-body canister 51 serves as an atmosphere port 55.

The main-body canister 51 includes a first adsorption chamber 12 and a second adsorption chamber 21 provided therein, the chambers being similar to the first adsorption chamber 12 and the second adsorption chamber 21 of Embodiment 1. A third adsorption chamber 61 that is filled with adsorbent 61a, such as activated carbon capable of absorbing and desorbing an evaporated fuel component, at a prescribed density, is provided in the second adsorption chamber 21 on the atmosphere port 6 side.

Since other configuration aspects are identical to those of Embodiments 1 to 4, identical component members are designated by reference numerals identical to those of these embodiments to omit the description thereof.

In Embodiment 5, the same effects as those in Embodiments 1 to 4 can also be implemented.

It is to be noted that a plurality of adsorption chambers may be provided in series in the trap canister 52. In that case, the adsorption chamber positioned closest to the atmosphere port 55 is formed to have a major diameter portion 31a and a projecting portion 31b that are filled with adsorbent and a apace portion 32 that is not filled with adsorbent on an outer peripheral portion of the projecting portion 31b in generally the same way as in the case of the third adsorption chamber 22 of Embodiments 1 to 4.

### Other Embodiments

The treatment apparatus for evaporated fuel according to the present invention may have a plurality of adsorption chambers. The number of the adsorption chambers and shapes thereof may be set arbitrarily if the adsorption chamber positioned closest to the atmosphere port has a major diameter portion 31a and a projecting portion 31b that are filled with adsorbent and a space portion 32 that is not filled with adsorbent on an outer peripheral portion of the projecting portion 31b.

1. A treatment apparatus for evaporated fuel comprising: a tank port; a purge port; an atmosphere port; a channel that communicates the tank port or the purge port and the atmosphere port; and, a plurality of adsorption chambers having adsorbent placed therein, the adsorbent adsorbing and desorbing a fuel component of evaporated fuel,
wherein said adsorption chamber positioned closest to said atmosphere port has: a major diameter portion filled with said adsorbent over all a cross section of said channel; a projecting portion that projects from said major diameter portion toward said atmosphere port and is filled with said adsorbent; and, a space portion that is formed between said projecting portion and an inner wall of said channel and is not filled with said adsorbent, and
end surfaces of said major diameter portion and said projecting portion on the atmosphere port side are breathable.

2. The treatment apparatus for evaporated fuel according to claim 1, wherein a partition wall is provided between said projecting portion and said space portion so as to block air flow between an outer peripheral surface of said projecting portion and an inner peripheral surface of said space portion.
